(19) United States
(12) Patent Application Publication
(10) Pub. No.: US 2013/0095213 A1
(43) Pub. Date: Apr. 18, 2013

(54) Texture and Flavor Enhancer and Use in Food Preparation

(71) Applicant: Jeffrey Walters, Fort Pierce, FL (US)

(72) Inventor: Jeffrey Walters, Fort Pierce, FL (US)

(21) Appl. No.: 13/636,773

(22) PCT Filed: Mar. 23, 2011
(86) PCT No.: PCT/US11/29676

§ 371 Date: Jan. 3, 2013

Related U.S. Application Data
(60) Provisional application No. 61/316,445, filed on Mar. 23, 2010.

(51) Int. Cl. A23L 1/221

(52) U.S. Cl. CPC A23L 1/221
USPC 426/87; 426/638; 426/549

(57) ABSTRACT

Disclosed herein is a method of enhancing flavor of a food product. The method includes incorporating a composition predominantly derived from chia seed. Also disclosed herein are food products and articles of manufacturer with low sodium and/or sugar content without a decrease in saltiness and/or sweetness.

### BACKGROUND

The latent nutritional values present in many vegetables, particularly the oilseed vegetables such as soybeans and other legumes and cottonseeds, is well known. Utilization of these nutrient sources has been severely hampered, however, by the presence in these vegetable nutrients of naturally occurring substances that interfere with their digestibility and palatability. The principal deficiencies of vegetable nutrient sources are their typical beany flavor and their poor digestibility. The beany flavor, particularly when used as an animal feed can often be overcome by cooking or toasting. However, the poor digestibility of vegetable nutrients, such as soy protein, is caused by the presence of oligosaccharide sugars and additional antinutritional factors, such as trypsin inhibitor and proteins that show antigenicity. Finally, since these crude feedstock materials are products of the agricultural and food processing industries, their consistency and/or quality can be variable.

### DETAILED DESCRIPTION

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

According to one embodiment, the subject invention pertains to a method of enhancing sensitivity to sweetness and/or saltiness in a food product composition. The method involves including in the food product a composition predominantly derived from chia seed. As used herein, chia seed pertains to seed of a plant belonging to the species Salvia hispanica. The chia composition may be a powder, semi-solid or liquid form. The food product compositions taught herein enable the production of healthier food products based not only on increased nutritional levels, but also based on the ability to include less sugar and/or salt without diminishing the palatability of the food composition.

In another embodiment, the invention pertains to a method of preparing a food product that does not require mastication (without needing to chew with teeth), the method comprising obtaining a food product powder produced by milling a dried fruit, vegetable and/or meat containing food product; obtaining a milled chia powder composition; and admixing the food product powder with the milled chia powder composition to achieve an enhanced food product powder composition. The milled chia powder composition is added at a sufficient quantity to enhance the sweetness and/or saltiness flavor of the food product powder relative to the absence of any milled chia powder. The admixture of chia powder with milled dried food product powder may be reconstituted in water prior to consumption.

In a specific embodiment, the enhanced food product powder composition includes 0.01 percent to 80 percent milled chia powder composition, or any one hundredth percent within such range. In an even more specific embodiment, the enhanced food product powder composition possesses 1-30 percent milled chia powder.

Dried fruit, vegetable and/or meat containing food products may be obtained by spray-drying, freeze-drying, air-drying, drum drying and/or evaporation techniques according to convention techniques well known in the food preparation industry. U.S. Pat. Nos. 7,569,244, 6,254,919; 6,146,669; 5,534,280, 5,260,088; 5,256,438, and 4,438,150 are cited to as non-limiting examples of techniques that may be used to obtain a dried fruit, vegetable and/or meat containing food product and processing such dried food product, and are incorporated herein in their entirety to the extent not inconsistent with the teachings herein.

The dried vegetable containing food product may contain, but is not limited to, buckwheat, rhubarb, sorrel, beets, spinach, Swiss chard, cantaloupe, casaba, cucumber honeydew, pumpkin, summer squash, winter squash, watermelon, barley, corn, hominy, millet, oat, rice, rye, sorghum, sugar cane, wheat, aloe, asparagus, chives, garlic, leek, onion, sarsaparilla, shallot, cottonseed, marshmallow, okra, sweet potato, broccoli, brussel sprouts, cabbage, cauliflower, collards, garden cress, horseradish, kale, kohlrabi, mustard, radish, rutabaga, turnip, watercress, bell pepper, cayenne pepper, paprika, eggplant, white potato, tomato, anise, caraway, carrot, celeriac, celery, coriander, dill, fennel, parsley, parsnip, acacia, alfalfa, black-eyed pea, broad bean, carob bean, chick pea, common beans, green beans, lentil, licorice, lima bean, mesquite, pea, peanut, tamarind, tragacanth, and combinations thereof.

According to another embodiment, the invention pertains to a baby-food composition that is nutritious, and possesses enhanced flavor and texture. In a specific embodiment, the baby food includes vegetable material prepared such as by cleaning, peeling and comminuting the whole food or part thereof as distinguished from further processing such as by drying, milling into a flour and/or further refining. In another embodiment, the vegetable or fruit can be first dried and milled into a flour and then added to the baby food.

The inventors realize that baby food compositions described herein must also be organoleptically suitable for incorporation into a baby food composition. Infants are known to display an aversion to bitter tastes at a very early age (Trahms, in Nutrition in Infancy and Childhood, Pipes and Trahms, Eds, Mosby, St. Louis, 1993, pp. 181-194; Kajiura et al, Developmental Psychobiol 25:375-386; Rosenstein et al., Child Develop 59:1555-1568, 1988 which are incorporated by reference). Furthermore, it has been shown that children respond to bitter tastes in much the same way as adults (Lawless, Am Diet Ass'n 85:577-585, 1985 which is incorporated by reference). Thus, a food product having a strong bitter taste would not be acceptable in a baby food composition. Assessment of the palatability level to determine the amount of chia powder needed to enhance palatability of the baby food compositions for babies and infants. Because the adult perception of tastes closely follows that in the infant, it is possible to conduct such testing in adults (Id.). Furthermore, food preferences or aversions of the adult caring for the infant are known to influence which foods are offered to the infant (Trahms, supra; Brooks, The Wall St J, Dec. 4, 1996 pp A1, A6 which are incorporated by reference). Standard testing procedures for sensory evaluation are known in the art (see, for example, Stone and Sidel in Sensory Evaluation Practices, Academic Press, Orlando, 1985, pp 58-86, 227-252 which is incorporated by reference).

Infants also tend to reject or at least show a diminished acceptance of strong flavors and, in particular strong-flavored vegetables (Lowenberg, in Nutrition in Infancy and Childhood, Pipes and Trahms, Edds, Mosby, St. Louis, 1993, pp. 165-180; Brooks, supra; Lawless, supra; Ashbrook et al, J Nutrition Ed 17:5, 6, 46, 1985; Beal Pediatrics 20:448-456, 1957 which are incorporated by reference). Therefore, vegetables suitable for use in a baby food composition, preferably, do not have a strong flavor. The testing of vegetables for the presence of strong flavors can also be readily performed by the skilled artisan using routine methods (Stone and Sidel, supra which is incorporated by reference).

Testing for organoleptic acceptability could, for example, be performed in infants after obtaining informed consent from parents in a double-blind, randomized controlled study. Infants of ages from about 4 months to about 12 months would be fed a series of baby food composition prepared with a particular reconstituted admixture of dried food product powder/chia powder having a given ratio percentage of dried food product powder to chia powder or a “standard” baby food composition that includes a reconstituted dried food product powder without chia powder. The adult feeding the infant would then record acceptability and tolerance including amount offered, amount consumed and amount refused by the babies as well as the number, color and consistency of stools. Acceptability rating would be performed by methodology known in the art (for example, Stone and Sidel, Sensory Evaluation Practices, Academic Press, Inc., Orlando, 1985, pp. 58-86 which is incorporated by reference). The results would be analyzed and baby food compositions showing acceptance comparable to or greater than that of the standard vegetable would be considered suitable for use as an infant food.

In another embodiment, the dried food product contains milled dried vegetables or fruits, such as, but are not limited to apple, apricot, alfalfa, artichoke, asparagus, avocado, azerole, banana, beets, bilberry, blackberry, blueberry, bok choy, broccoli, cabbage, capsicum, cactus fruit, cane, cantaloupe, carrot, celery, cherimoya, cherry, coconut, corn, cranberry, cucumber, currants, durian, egg plant, ferijoa, figs, gooseberry, grapes, grapefruit, green barley, green beans, green lettuce, guava, ita palm, japonica, jujube, kale, kiwi, kumquat, legumes, lemon, lettuce, lime, loquat, oranges, mango, melon, mushrooms, nectarine, olives, papaya, parsley, passion fruit, pear, peas, persimmon, pineapple, plum, pomegranate, potato, pumpkin, prune, olive, quince, radish, raspberry, rhubarb, rice, rambutan, spinach, squash, starfruit, strawberry, sweet potato, tomato, tubors, ugli, voguanga, watermelon, xigua, yams and/or zucchini.

According to a further embodiment, the subject invention pertains to an article of manufacturer comprising a container containing an admixture of dried food product powder and chia powder and written instructions regarding instructions on how to make a baby food composition therefrom by placing a sample of the admixture in an ingestible liquid, mixing the liquid/admixture to a desired level.

Another embodiment pertains to a method of enhancing the sweetness and/or saltiness of a food product containing sugar and/or salt. The method involves incorporating a chia containing composition to said food product, wherein said incorporating the chia containing composition achieves a level of sweetness and/or saltiness in said food product with a lower sugar and/or salt content compared to a higher level of sugar and/or salt content in said food product without said chia containing composition. The chia containing composition may take the form of a powder, semi-solid or liquid composition, or combination thereof, containing material derived from chia seed. The food product, includes but is not limited to a baked good, canned good, frozen good, jarred good, or dehydrated food item, candy, or some combination thereof. In a specific embodiment, the food product pertains to bread, muffin, or cake. In another embodiment, the food product pertains to soup, canned vegetables, chips, crackers, wafers, cookies, candy bars, nutritional bars, pasta, frozen dinners, frozen vegetables or cereal.

In a specific embodiment, the chia containing composition includes 0.1-80 percent, by weight, chia-derived material.

In an alternative embodiment, the food product contains 0.1-50 percent, by weight, of chia derived material.

According to another embodiment, the invention pertains to an article of manufacture comprising a container and a food product disposed within said container. The article of manufacture may further include packaging material that indicates the article of manufacture is reduced in salt, sugar and/or sodium content. The packaging material by include a label or indicia associated with the container.

Another embodiment pertains to an article of manufacture including a composition predominantly derived from chia seed and packaging material indicating that the composition enhances flavor. The article of manufacture may specifically indicate implicitly or explicitly that the composition enhances sweetness, and/or saltiness of food.

Therefore, the flavor enhancer of the present invention can also be used in meat applications, e.g., to enhance beef or poultry flavour; vegetable applications, e.g., to enhance paprika, carrot, mushroom, onion or garlic flavour; and dairy applications, e.g., to enhance cheese or butter flavour; bakery applications, e.g., to enhance the flavour of baked products; and to enhance the flavour of beverages. It can be added to food products whether fresh, frozen, vacuum preserved or dried; processed or unprocessed; liquid or solid; alcoholic or non-alcoholic; for human consumption or animal consumption. Food products to which it can be added include but are not limited to basic bouillons, such as beef stock, lobster stock, chicken stock, fish stock, vegetable stock, and the like; snacks, such as, e.g., cheese crackers, crisps, and the like; sauces and dressings, such as cheese sauce, brown gravy, curry sauce, garlic sauce, dip sauces, dressings for salads and/or vegetables, and the like; soups, such as onion soup, beef noodle soup, and the like; mayonnaise, halvanaise, margarine, butter and the like; baked goods like croissants, bread , cake and crackers; ready to eat meals; seasonings, such as paprika seasoning, and the like; custard and whipped cream; chocolate flavoured products, like cocoa flavoured beverages, e.g., chocolate flavoured soy milk, or chocolate bars (to enhance the cocoa-flavour of these products). According to one preferred embodiment, the flavour enhancer is added to mushroom soup to enhance mushroom flavour.

According to other embodiments, the chia composition is used in enhancing dairy-type flavour notes (like cheese), vegetable-type notes (e.g. carrot, tomato, mushroom, onion) and spices (e.g. pepper (pepper heat note enhancement), garlic). A particularly new effect of the flavour enhancer according to the invention is the prolonged flavour perception. Addition of the flavour enhancer according to the invention to a food product makes the food product's taste last longer in the mouth (this is called the linger longer.RTM. taste effect).

Furthermore, creamy-tasting products taste more creamy and will obtain a thicker mouthfeel when the flavour enhancer according to the invention is added to the food product. The use of the chia composition will enhance the creaminess and mouthfeel of the food or feed product, essentially without increasing the viscosity of these food or feed compositions.

The flavour enhancer of the invention may be used as such or in flavouring composition, e.g. in combination with flavouring agents. In this context, the term ‘flavouring agent’ is used to indicate a compound or a mixture of compounds which is used to create a flavour which is not present in a product. The flavour enhancer may further be used as a compound in the production of processed flavours. Due to the high amount of free amino acids it may be used as a source of amino acids in the production of processed or reaction flavours.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention. The references referred to herein are incorporated herein in their entirety to the extent they are not inconsistent with the teachings herein.

1. A method of enhancing the sweetness and/or saltiness of a food product containing sugar and/or salt, said method comprising incorporating a chia containing composition to said food product, wherein said incorporating achieves a level of sweetness and/or saltiness in said food product with a lower sugar and/or salt content compared to a higher level of sugar and/or salt content in said food product without said chia containing composition.

2. The method of claim 1, wherein said chia containing composition comprises a powder, semi-solid or liquid composition, or combination thereof, containing material from chia seed.

3. The method of claim 1, wherein said food product comprises a baked good, canned good, frozen good, jarred good, or dehydrated food item, candy, or some combination thereof.

4. The method of claim 3 wherein said food product is bread, muffin, or cake.

5. The method of claim 1, wherein said chia containing composition comprises 0.1-80 percent, by weight, chia-derived material.

6. The method of claim 1, wherein said food product contains 0.1-50 percent, by weight, of chia derived material.

7. An article of manufacture comprising a container and a food product disposed within said container, wherein said container comprises packaging material that indicates said article of manufacture is reduced in salt, sugar and/or sodium content.

8. An article of manufacture comprising a composition predominantly derived from chia and packaging material indicating that said composition enhances flavor.

9. The article of manufacture of claim 8, wherein said flavor is sweetness, and/or saltiness.

10. An article of manufacturer comprising a containing and a food product disposed within said container, said food product not requiring mastication and comprising chia.

11. The article of manufacturer of claim 10, wherein said food product comprises 0.1-50 percent of material, by weight, derived from chia.
